(19) United States
(12) Patent Application Publication
(10) Pub. No.: US 2002/0182570 A1
(43) Pub. Date: Dec. 5, 2002

(54) Computer-based quality enhancement training program

(76) Inventors: Marguerite Claire Croteau, Marietta, GA (US); Kevin H. Dai, Clifton Park, NY (US); Max Herrell, Powder Springs, GA (US); Karen D. Riding, Castleton, NY (US)

Correspondence Address: PERKINS COIE LLP, PATENT-SEA, P.O. BOX 1247, SEATTLE, WA, 98111-1247, US

(21) Appl. No.: 09/872,152

(22) Filed: May 31, 2001

(51) Int. Cl. G09B 19/18

(52) U.S. Cl. 434/107

(57) ABSTRACT

Methods and systems for a computer-based quality enhancement training program. In one embodiment, the training program is a Six Sigma quality enhancement training program comprised of a series of multimedia display descriptions presented to a user on a computer display screen. In this embodiment, the training program includes an introduction comprising a case study and an overview of fundamental Six Sigma concepts. After the introduction, the program presents a main menu display description including an icon corresponding to each of the five core phases of the Six Sigma process. Selecting one of these five icons displays links to instructional subject matter related to that phase of the Six Sigma process. A phase quiz is presented upon completion of each phase and a knowledge check that serves as a final exam is provided at the end of the training program.

### TECHNICAL FIELD

The present invention relates generally to computer-based training, and more particularly, to a computer-based quality enhancement training program.

### BACKGROUND

In today's competitive business environment, companies are continually searching for ways to reduce costs. At one time it was widely held that the cost of producing defect-free products outweighed the benefits. Today, however, it is generally accepted that producing defect-free products at the outset is less expensive than responding to an occasional defect later. Consistent with this philosophy, a number of different quality enhancement programs have come to the fore in recent years to help companies increase the quality of their products. Continuous Process Improvement, Design for Quality, and Six Sigma are but three examples.

Six Sigma is a quality enhancement process that focuses on designing and monitoring everyday business activities in ways that minimize waste and resources while increasing customer satisfaction. Six Sigma provides specific methods for analyzing and improving processes so that defects and errors never arise in the first place. The phrase “Six Sigma” actually refers to a statistical measure of process capability that indicates how well the process is performing. For example, a process that is performing to a three sigma capability would experience 67,000 defects per million defect opportunities. In contrast, a process having a six sigma capability would experience only 3.4 defects per million defect opportunities. Thus, one goal of the Six Sigma quality enhancement process is to drive process capability to a six sigma level. Another goal of the Six Sigma process is to standardize the methods and processes that result in six sigma quality, and then integrate these standard methods and processes into the design cycle so that future products will have them built in.

The five core phases of Six Sigma methodology are define, measure, analyze, improve, and control. The define phase involves defining the processes that contribute to the functional problems. The measure phase involves measuring the capability of each process that offers operational leverage. The analyze phase involves analyzing the data to assess prevalent patterns and trends. The improve phase involves improving the key product/service characteristics created by the key processes. And finally, the control phase involves controlling the process variables that exert undue influence on process performance.

Each of the five core phases of the Six Sigma process has three basic steps. In the define phase, for example, the first step is to identify a project's CTQs. CTQ stands for “Critical To Quality” elements that are the key process or product characteristics required to meet the needs of a customer. The second step of the define phase is to develop a team charter that includes problem and goal statements, defines the project scope, and designates team participants. The third and last step of the define stage is to define a process map that illustrates the process that needs improvement. Each of the other core phases of the Six Sigma process can be similarly divided into three basic steps. A detailed description of the core phases of the Six Sigma process can be found in numerous references, such as Six Sigma, The Breakthrough Management Strategy Revolutionizing the World's Top Corporations, by Mikel Harry and Richard Schroeder, 1^{st} Edition, December 1999.

Companywide implementation of any quality enhancement process requires training the work force in the fundamentals of the process. Training is traditionally accomplished by attending live instructor-led training sessions. For large corporations having multiple divisions throughout the world, providing a standardized training program with live instructor-led training sessions can be very costly and time-consuming. Furthermore, the necessary use of different instructors at different locales invariably results in a nonuniform training approach. Therefore, a method for efficiently training a widely distributed work force in a quality enhancement process would be desirable.

### BRIEF DESCRIPTION OF THE DRAWINGS

FIG. 1 is a flow diagram of a routine for providing quality enhancement training in one embodiment.

FIG. 2 is a diagram illustrating a display description for presenting a selected Six Sigma case study.

FIG. 3 is a diagram illustrating a display description for presenting selected information about the Six Sigma quality enhancement process.

FIG. 4 is a diagram illustrating a display description comprising a main menu for the computer-based computer program in one embodiment.

FIG. 5 is a diagram illustrating a top menu of the main menu display description in one embodiment.

FIG. 6 is a diagram illustrating a display description for introducing a phase training module for the Six Sigma process.

FIG. 7 is a diagram illustrating a display description for introducing a lesson corresponding to a step of the phase module.

FIG. 8 is a diagram illustrating a display description for presenting a multiple-choice question in one embodiment.

FIG. 9 is a diagram illustrating a display description for presenting an answer to the multiple-choice question in one embodiment.

FIG. 10 is a diagram illustrating a display description that includes a “hot spot” training aid in one embodiment.

FIG. 11A is a diagram illustrating a display description that includes a “drag-and-drop” question format in one embodiment.

FIG. 11B is a diagram illustrating a display description that includes an answer to the “drag-and-drop” question in one embodiment.

FIG. 12 is a diagram illustrating a display description for presenting a summary of a step of a phase module.

FIG. 13A is a diagram illustrating a display description for presenting a phase quiz question in one embodiment.

FIG. 13B is a diagram illustrating a display description for presenting an answer to the phase quiz question in one embodiment.

FIG. 13C is a diagram illustrating a display description for presenting feedback on a phase quiz performance in one embodiment.

FIG. 14 is a block diagram illustrating components of a computer system for implementing the quality enhancement training program in one embodiment.

FIG. 15 is a flow diagram of a routine for providing a selected core phase drop-down list in one embodiment.

FIG. 16 is a flow diagram of a routine for providing selected training material in one embodiment.

FIG. 17 is a flow diagram of a routine for returning a user to a previous stopping point in a computer-based training program in one embodiment.

### DETAILED DESCRIPTION

The following disclosure provides methods and systems for a computer-based quality enhancement training program. In one embodiment, the training program is comprised of a series of interactive multimedia display descriptions presented to a user on a computer display screen. The training program in this embodiment can be implemented on a general purpose computer, such as a personal computer, using a computer-readable medium, such as CD-ROM, floppy disk, DVD, VCD, or ZIP disk based software. Alternatively, the training program can be implemented in a distributed computing environment where tasks or modules are performed by remote server computers linked via an intranet or Internet computer network. Although in one embodiment the computer-based training program is directed to the Six Sigma quality enhancement process, it will be understood that the methods and systems disclosed can be used for teaching a multitude of different subjects that are not limited to the quality enhancement arts.

The computer-based training program begins by providing the trainee, or user, with an introduction to the quality enhancement subject matter. In the Six Sigma embodiment, display descriptions are provided that describe a case study that will be used throughout the training to provide a context for examples and demonstrations of the concepts being taught. An overview of the Six Sigma process follows the case study and introduces the user to some fundamental concepts and terminology of Six Sigma. The next sequence of display descriptions in the introduction explains to the user how the training program is structured and how it will proceed.

After providing the user with the necessary introductory information, the training program provides a main menu display description that includes an icon for each of the five core phases of the Six Sigma quality enhancement process. The five core phases are the define phase, the measure phase, the analysis phase, the improvement phase, and the control phase. Selecting one of the five phase icons displays a drop-down list containing links to five different phase sections: an introduction section, three lesson sections, and a review section that contains a phase quiz and a feedback display description. By selecting one of the links, the user can access display descriptions corresponding to that particular phase section and work through the phase section accordingly. After the user has worked through all of the sections of one of the core phases of the Six Sigma process, he or she can proceed to another phase until all of the phases have been completed. A phase is considered complete when the user has completed the three lesson sections and the phase quiz and has accessed the feedback display description.

As the user proceeds through the training program, phase menus located on the upper portion of the display descriptions will visually change to indicate which phases and lessons have been completed. If the user exits the training program without completing it, a bookmark function provides the option of returning to the main menu or to where the user left off. If the user chooses to return to where he or she left off, the program will branch to the corresponding phase section and display a menu showing the lesson most recently completed.

In one embodiment, a “knowledge check” that serves as a final exam is provided at the end of the training program. To qualify for the knowledge check in this embodiment, the user should complete the five individual phase quizzes with a cumulative quiz score of 70 percent or greater. If the cumulative quiz score is less than 70 percent, then the user is instructed to take a review quiz. A score of 70 percent or greater on the review quiz indicates that the user has now sufficiently mastered the subject matter to proceed on to the knowledge check. If the user's score on the review quiz is less than 70 percent, then the user can call an instructor for assistance or retake the computer-based training program from the beginning.

Use of the computer-based training program disclosed herein alleviates the need for users to attend instructor-led training sessions at off-site training facilities. This program also provides the user with the flexibility to learn the subject matter at his or her own pace. Yet another benefit of this training program is the uniformity of training it offers. Having a widely distributed work force using the same training curriculum ensures that companywide implementation will result in a standardization of processes.

Although the following description provides specific details for a thorough understanding of several embodiments of the computer-based training program provided, one of skill in the relevant art will understand that these embodiments can be practiced without some of these details. In other instances, one skilled in the art will appreciate that the computer-based training program can include additional details without departing from the scope of the described embodiments. Certain embodiments of the training program will be described in the context of computer-executable instructions executed by a general-purpose computer. The structures and functions related to computer-executable routines and corresponding computer implementation systems are well known, and have not been shown or described in detail here to avoid unnecessarily obscuring the described embodiments. Although embodiments of the computer-based training system are described in the context of the Six Sigma quality enhancement process, it will be understood that the methods and system disclosed are equally applicable to a myriad of other subjects, and are not limited to the field of quality enhancement.

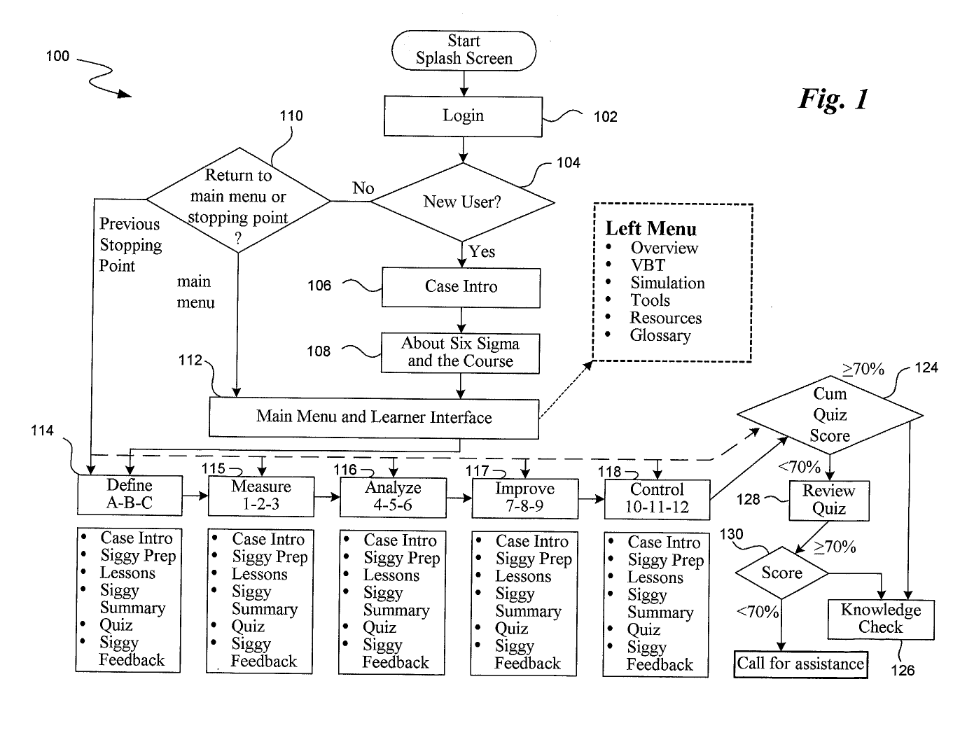

FIG. 1 is a flow diagram of a routine 100 for providing quality enhancement training in accordance with an embodiment. The training routine 100 is implemented in one embodiment on a user computer system performing computer-executable instructions stored on a computer-readable medium. Implementation of the routine 100 includes presenting interactive multimedia display descriptions containing audio, video, and graphical training material to the user in accordance with the flow diagram. The display descriptions can include, for example, instructional material comprising animated sequences or “builds” in which graphics or still photographs are timed with changing audio files. Other display descriptions can include multiple choice questions that require user interaction in selecting the correct answer. These examples are by no means exhaustive. Indeed, numerous display description formats can be used to convey quality enhancement instructional material in accordance with the routine 100. Similarly, throughout this disclosure the routine 100 is described for the purpose of illustration in the context of the Six Sigma quality enhancement process. As will be understood by those of skill in the relevant art, however, the training routine 100 can be favorably practiced with other curriculum as well.

In block 102 of the routine 100, the user logs on to the system by entering an appropriate user ID and password on a logon display description. In decision block 104, the system determines whether the user is new to the training program. If the user is new, then in block 106, the system provides a series of display descriptions that describe a case study to provide a context in which the training material is presented and applied. In block 108, the system provides various display descriptions that introduce the user to the Six Sigma process and explain how the training program will proceed. In block 112, first-time users are presented with a main menu display description that serves as the main user interface for the training program.

The opening sequence as described above is only provided the first time a user accesses the training program. After an initial session, in block 110 returning users are prompted as to whether they want to return to the main menu display description or proceed directly to the point in the training program where they left off. Returning users electing to proceed directly to the point where they left off are routed accordingly through a bookmarking function. Conversely, first-time users completing block 108, and returning users electing to do so, are routed to the main menu display description in block 112.

The main menu display description includes a top menu bar containing five phase module icons. The five phase module icons correspond to the five core phases of the Six Sigma process, namely, the define phase, the measure phase, the analyze phase, the improve phase, and the control phase. Selecting one of the phase module icons shown on the main menu display description causes a drop-down list to appear that contains a phase introduction link, three phase lesson links that cover the three steps of that phase, and a phase review link. By selecting one of the links in the drop-down list, the user can proceed to that section of the phase module and view the corresponding training material. A phase module is complete once the user has completed the three lessons and a phase quiz included in the phase review. From the main menu display description in block 112, the user can select any of the phase modules shown in blocks 114 through block 118. The user can elect to perform the five different phase modules in any order he or she chooses, however, all of the phase modules must be complete before the routine proceeds to decision block 124.

In decision block 124, if the user's cumulative score on the phase quizzes is 70 percent or greater, then the user is allowed to take a “knowledge check” in block 126. In one embodiment, the knowledge check provides a series of display descriptions that comprise a final exam for the entire training program. This final exam, for example, can include 75 to 100 questions with a question addressing each of the different learning objectives covered in the five different phase modules. In one embodiment, this final exam is graded pass or fail based on achieving a score of 70 percent or greater. In other embodiments, other grading criteria can be applied to the final exam such as a graduated scale corresponding to traditional letter grades A-F.

If the user's cumulative score on the phase quizzes is less than 70 percent, then the user is directed to a course review quiz in block 128 that includes all of the questions from the previous phase module review quizzes. In decision block 130, if the user receives a score of less than 70 percent on the course review quiz, then the user is instructed to seek assistance from a qualified instructor. Conversely, if the user scores 70 percent or higher on the course review quiz, then the user is allowed to proceed to the knowledge check in block 126.

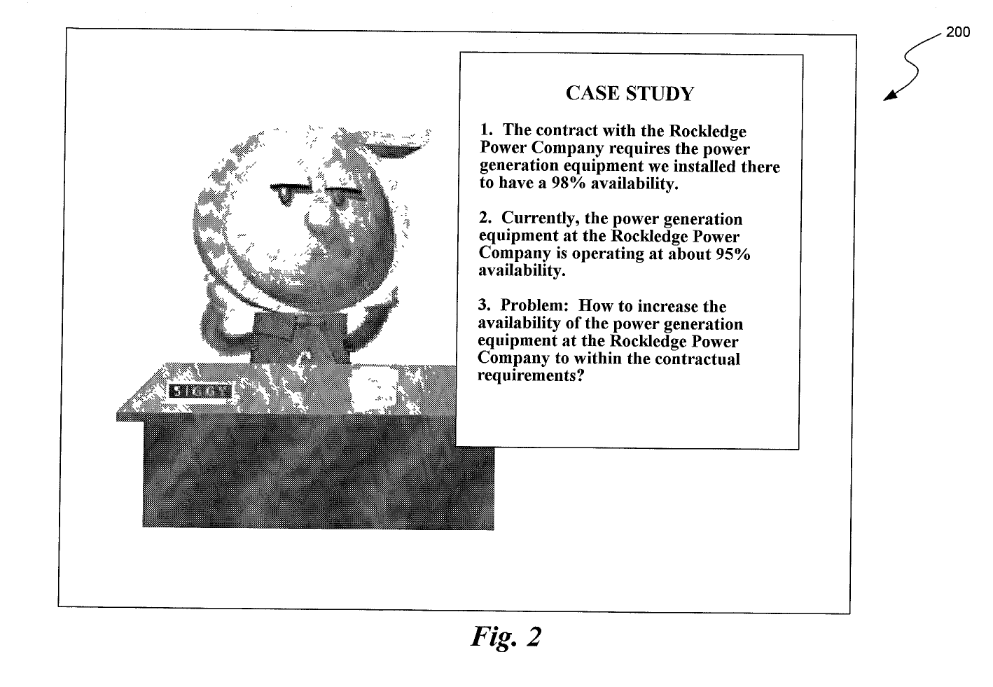

FIG. 2 is a diagram illustrating a display description 200 for presenting a selected Six Sigma case study in accordance with an embodiment. The Six Sigma case study can be presented using multimedia audio, video, and graphical features. The display description 200, for example, provides details in both text and audio of a “real life” quality problem facing a business. This quality problem provides a backdrop against which the subject matter of the Six Sigma process is explained throughout the training program. The display description 200 is only one example, and multiple display descriptions may be necessary to provide an adequate description of a selected case study.

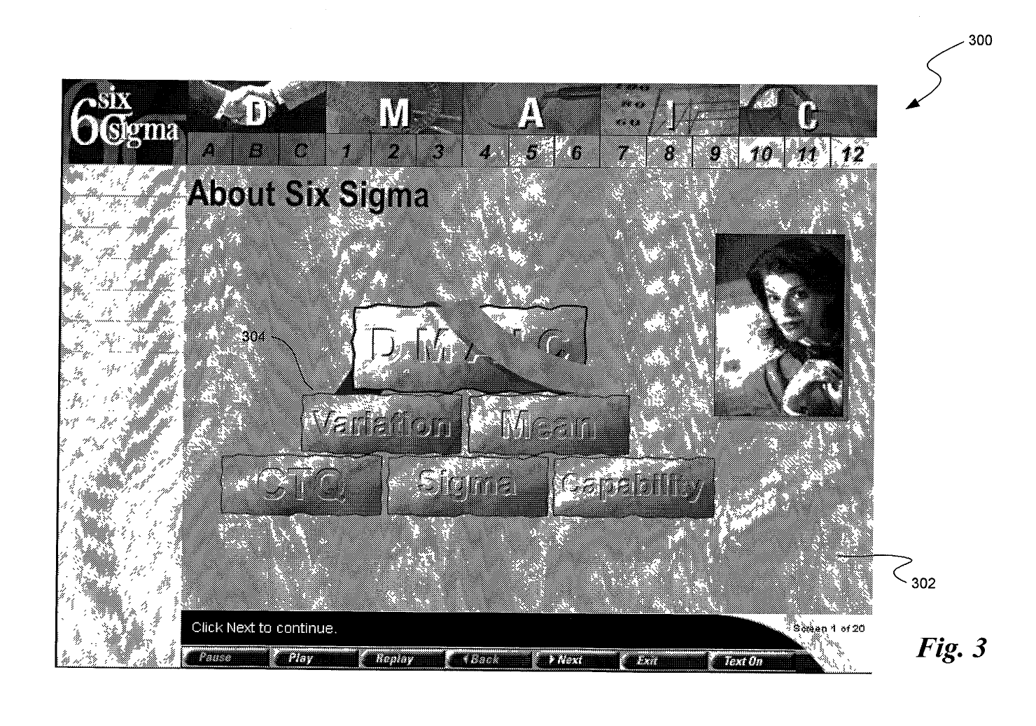

FIG. 3 is a diagram illustrating a display description 300 for presenting selected information about the Six Sigma quality enhancement process in accordance with an embodiment. Audio, video, and graphical data can be used in multimedia format to adequately explain the basic fundamentals of the Six Sigma process. A number of graphical icons 304 representing various aspects of the Six Sigma process are presented in a display field 302. By selecting one of the icons 304, additional display descriptions can be accessed that contain more information about that particular aspect of the Six Sigma process. The additional display descriptions can, for example, explain the different phases of a Six Sigma project, the steps involved with executing each phase, and the different proficiency levels attainable by project participants such as the green belt, black belt, and master black belt levels. Accordingly, the display description 300 is but one example of the formats and content that can be used to provide selected information about the Six Sigma process in accordance with this disclosure.

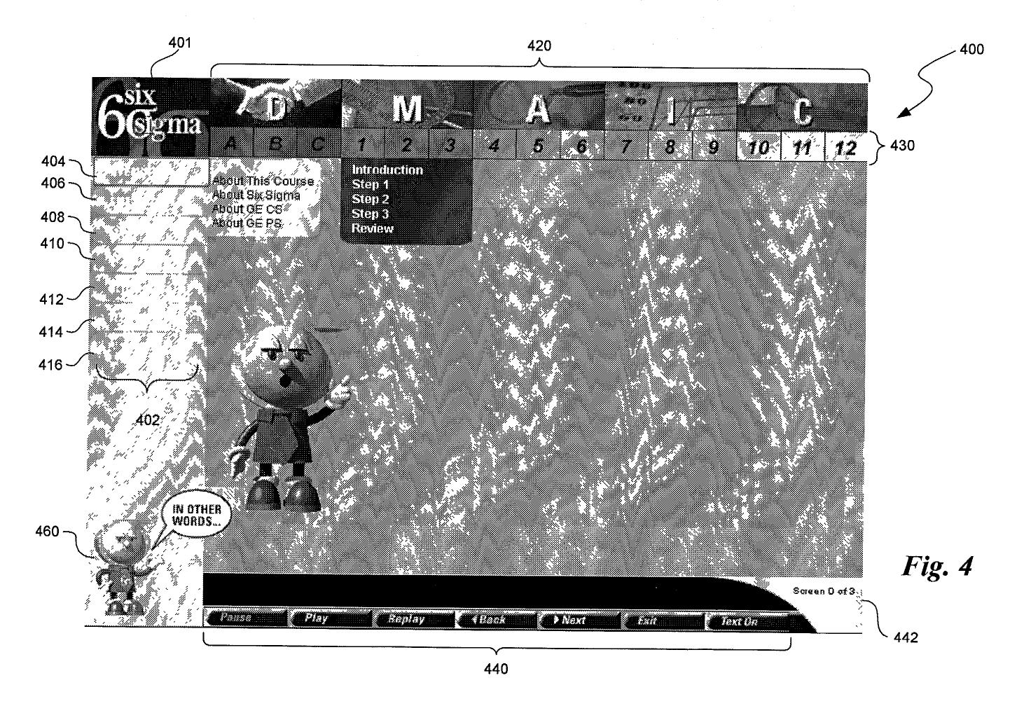

FIG. 4 is a diagram illustrating a display description 400 comprising a main menu for the computer-based training program in accordance with an embodiment. In one aspect of this embodiment, the basic format, graphics, menus, and icons shown on the display description 400 can be common to many of the display descriptions contained in the training program. For example, a course title and insignia symbol 401, a left menu 402, a top menu 420, and a navigation bar 440 may be common features of many of the display descriptions in the training program.

The left menu 402 includes an overview icon 404, a simulation icon 406, a tools icon 408, a resources icon 410, a glossary icon 412, a “tell me more” icon 414, and a summary icon 416. In one embodiment, selecting one of these icons causes a related drop-down list to be displayed. For example, selecting the overview icon 404 displays a drop-down list 405 including four links. Selecting the first link brings up display descriptions containing information about the training program. Selecting the second link brings up information about the Six Sigma process. Selecting the third and fourth links brings up display descriptions containing company-specific information. In another embodiment, selecting one of these icons will bring up another display description that contains more information related to the particular icon. For example, selecting the “tell me more” icon in this embodiment activates a display description that contains more information on the particular topic being addressed by the display description 400.

Selecting the simulation icon 406 causes a drop-down list to be displayed containing a second case study link. The second case study is intended to further educate the user in the Six Sigma process. The user can follow this entire case study through from beginning to end without regard to the step or phase in which the particular activities occur. It is recommended in the course introduction that the user work through each of the five phase modules before perusing the second case study in the simulation. The tools icon 408 links the user to information about various tools the user may need as he or she works through a Six Sigma project. Tools such as pareto charts, histograms, and cause and effect diagrams are included in one embodiment. The resource icon 410 links the user to additional Six Sigma resources, such as company web sites, documents, articles, or other materials. The glossary icon 412 links the user to definitions for various Six Sigma terminology.

The first five icons on the left menu 402 are available at any time throughout the training program. Conversely, the remaining two icons 414 and 416 are only active at selected times. For example, the tell me more icon 414 becomes active at different points throughout the course when there is additional information available on a particular topic. Similarly, the summary icon 416 becomes active only after the user has completed the five phase modules and is ready to conclude the course.

The display description 400 includes a top menu 420 containing icons corresponding to the five phase modules. Selecting any one of these icons causes a drop-down list such as 422 to be displayed containing five links: a phase introduction link, three lesson links covering each of the three steps of that phase, and a phase review link. Selecting one of the links in the drop-down list causes corresponding training material to be displayed. The top menu 420 also includes a locator bar 430 to indicate through visual signals which phase modules and lessons have been completed and, thus, where in the training course the user is at a particular time. In the illustrated embodiment, the locator bar 430 comprises numbered blocks situated below the phase module icons in the top menu 420.

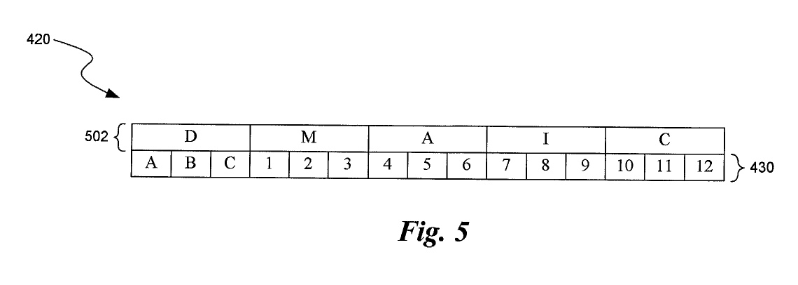

FIG. 5 is a diagram illustrating the top menu 420 for the purpose of describing the locator bar 430 in accordance with an embodiment. Icons corresponding to each of the five phase modules are shown in a top row 502. Numbered blocks corresponding to the three lessons in each phase module are shown on the locator bar 430. In this embodiment, the numbered blocks are shaded in as the user completes the corresponding lesson to indicate where in the course the user is at a particular time. For example, if the user had finished all of the design phase module and was at lesson two of the measure phase module, then the top menu 420 would appear as shown in FIG. 5 with the completed and started phase modules and lessons shaded in.

Returning to FIG. 4, the display description 400 also includes a navigation bar 440 in the lower portion of the display description. The navigation bar 430 contains a number of navigation icons that permit the user to navigate through the training material. The pause, play, and replay icons can be used as their names imply to control the video portions of the training program accordingly. Selecting the back icon replaces the current display description with the previous display description. Selecting the next icon replaces the current display description with the following display description. Selecting the exit icon allows the user to exit the course at the present location. The ending point and any user input data to that point are stored accordingly in a suitable memory device.

Written instructions, or “cues,” that guide the user through the training program, such as “click next to continue,” are shown at all times in a text box 450 positioned above the navigation bar 440. A “text on” icon 434 on the navigation bar 440 gives the user the ability to switch between audio narration and written script version of the narration. If the text on icon is selected, then the audio narration will stop and a textual script version of the narration will be displayed in the text box 450 along with the guide cues. Conversely, deselecting the text on icon starts the audio narration and terminates the textual version of the narration. The ability to switch between audio narration and written script has a number of advantages. For example, having the option of textual narration means that the training program is accessible to users who are hearing impaired. The textual version of the narration can also used by those with English as their second language who prefer to read a script. The textual narration also allows the training program to be used in a shared office environment where audio implementation may not be an option.

In the lower right portion of the display description 400 is a yellow page count field 442 that tells the user which screen number the user is on within each step of the training program. In the lower left portion of the display description 400 is a “hot spot” 450 that is displayed at various points during the training program. As will be explained in greater detail below, the hot spot 450 is an “in other words” hot spot, and selecting this hot spot brings up additional explanatory material either on the current display description or in a separate text box. This feature recognizes that some of the training material may need to be presented in greater detail or in more than one context to meet the learning needs of the user.

The content which is the focus of each display description appears in a presentation area 470 that occupies a central portion of the display description 400. The presentation area 470 can display a variety of interactive media content to instruct the user in the fundamentals of the Six Sigma process. For example, the presentation area 470 can display multiple choice questions or graphical illustrations related to the particular subject matter addressed in a given phase module. If an illustration is used, then “branching” hot spots can be provided on the illustration enabling the user to access textual information about different aspects of the illustration. By selecting a branching hot spot on a diagram, for example, the user can view a close-up of that particular part of the diagram with accompanying descriptive text. Similarly, “word choice” hot spots can be used as instructional aids by presenting a sentence with a word choice option where only one word choice is the correct option. An example of such a word choice hot spot is “training is/is not an integral part of the Six Sigma process.”

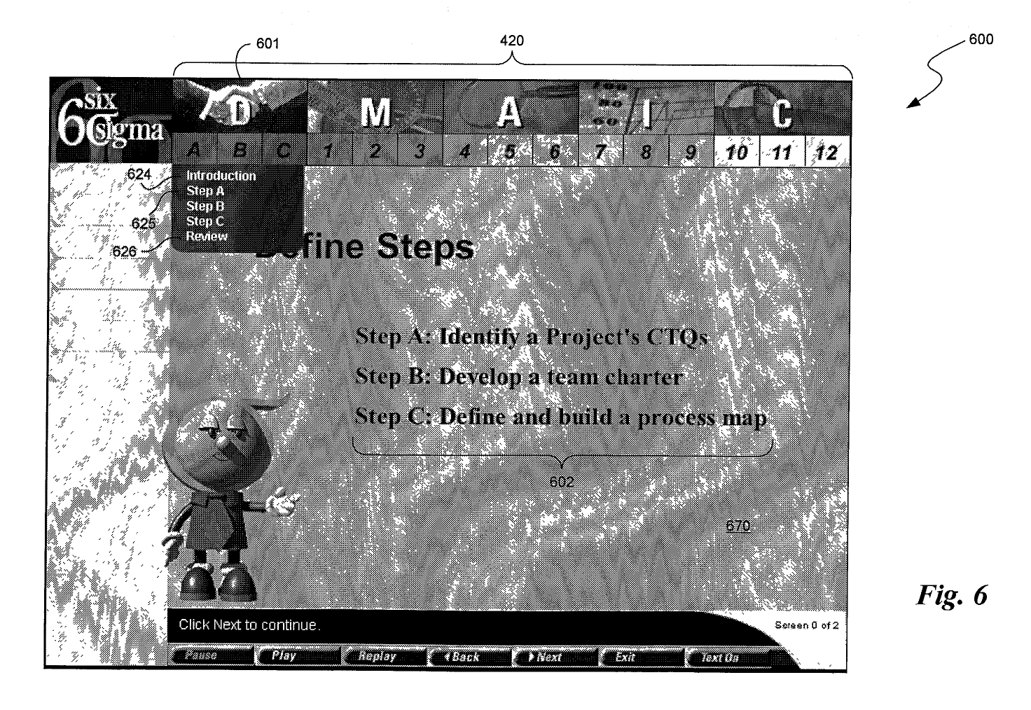

FIG. 6 is a diagram illustrating a display description 600 that includes a drop-down list 622 in accordance with an embodiment. The drop-down list 622 is displayed when the user selects a define icon 601 and includes an introduction link 624, a step A link 625, and a review link 626. By selecting the introduction link 624, the user brings up an introduction to the define phase module in a presentation area 670. The introduction in the illustrated embodiment is comprised of the three steps 602 of the define phase. Subsequent display descriptions are also presented as part of the introduction that provide additional Six Sigma objectives and tasks associated with the define phase. In one embodiment, these subsequent introductory materials include two elements: The first element is an audio presentation featuring a dialogue between a customer and an individual playing the role of a Six Sigma trainee. This dialogue establishes the progress of the case study to date and sets the stage for the define phase module. The second element of the introductory materials in this embodiment consists of an introduction to the define phase objectives.

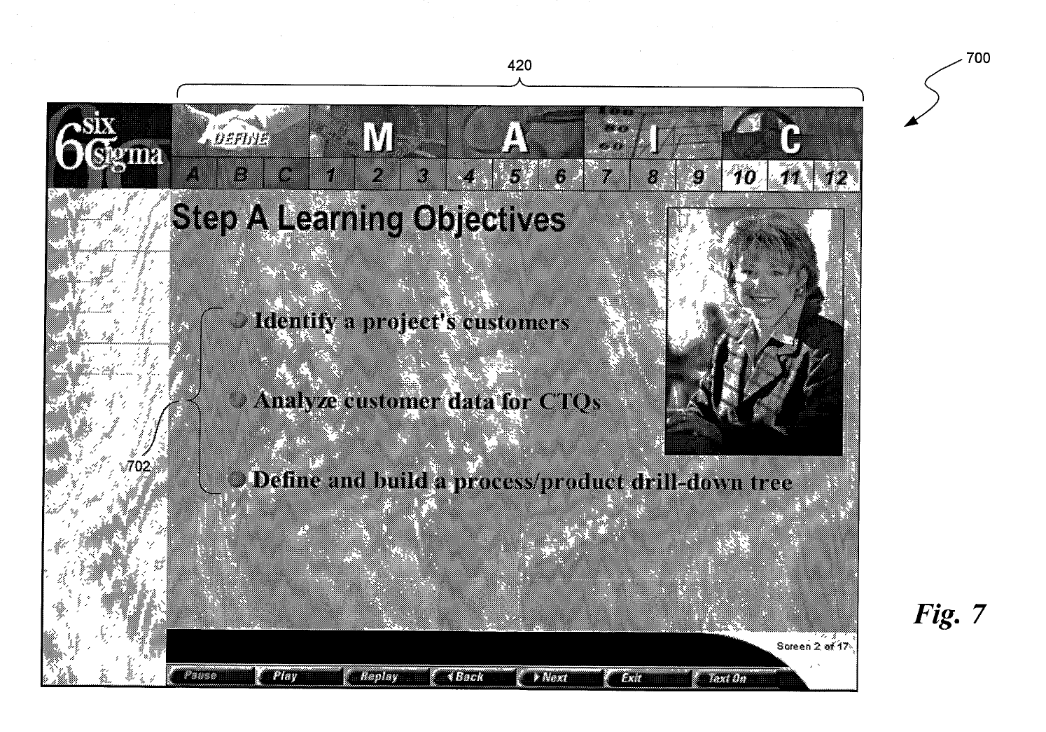

FIG. 7 is a diagram illustrating a display description 700 for introducing a phase lesson in accordance with an embodiment. In one embodiment, the display description 700 is presented after the user has selected the step A link 625 in the define module drop-down list 622 as shown in FIG. 6. Objectives 702 of step A of the define phase are shown in a presentation area 770. The display description 700 and subsequent lesson display descriptions provide instructional material corresponding to the three steps (i.e., A, B, and C) associated with the define phase. As explained above, a case study that complements the subject matter is woven into the instructional material to facilitate understanding.

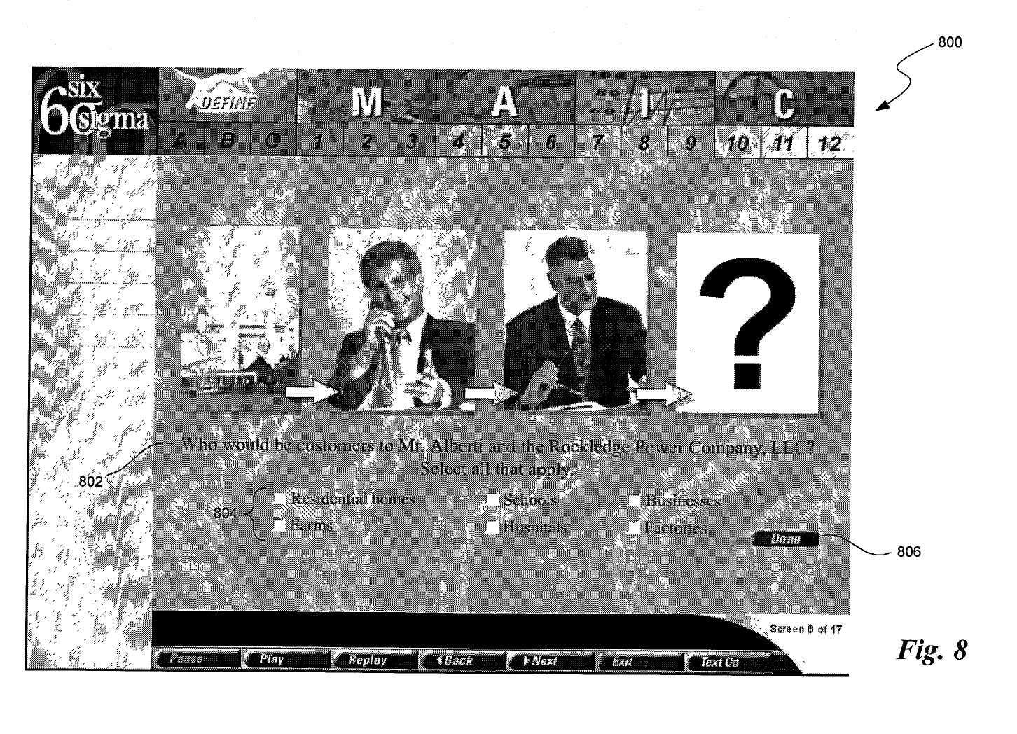

FIG. 8 is a diagram illustrating a display description 800 for providing Six Sigma instructional material in accordance with an embodiment. It will be understood by those of skill in the relevant art that the display description 800 is but one example of the various types of instructional display descriptions that can be included in the Six Sigma training program in accordance with the present disclosure. For example, display descriptions containing audio/visual content, build sequences, drag-and-drop sequences, and multiple choice questions are also included in the Six Sigma training program. The display description 800 in the illustrated embodiment presents a multiple choice question field 802. Still photographs 806 provide a graphic contextual background to the question 802. The user interacts with the display description 800 by selecting one or more boxes 804 corresponding to the correct answers to the question 802. After the user has selected one or more of the boxes 804, the user selects a done icon 806 to bring up an answer display description.

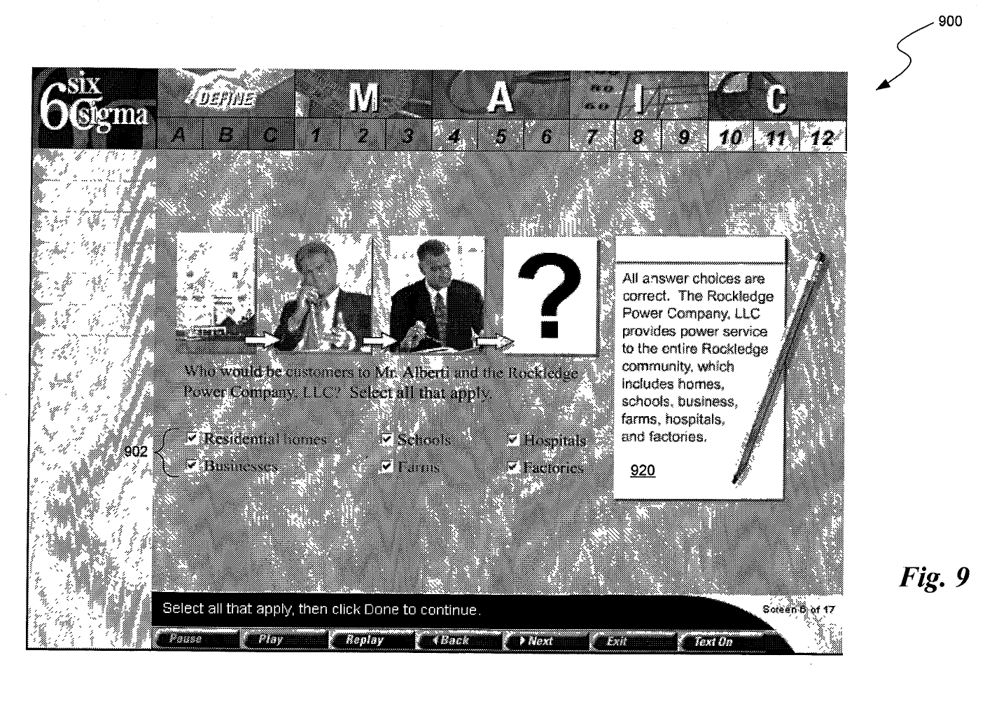

FIG. 9 is a diagram illustrating an answer display description 900 in accordance with an embodiment. The display description 900 includes a question portion 902 that repeats the question 802 shown in FIG. 8 and indicates the answers selected by the user. An answer box 920 explains the correct answer to the question posed.

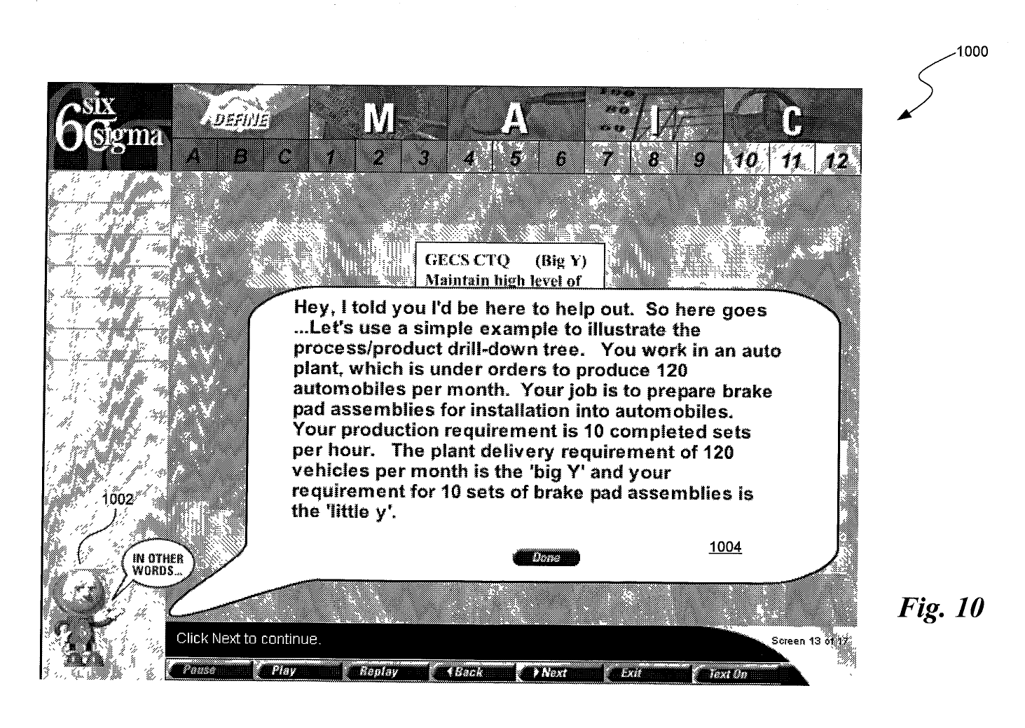

FIG. 10 is a diagram illustrating a display description 1000 that includes a hot spot training aid in accordance with an embodiment. The hot spot training aid of the illustrated embodiment is an “in other words” hot spot 1002 located in the lower left portion of the display description 1000. By selecting the hot spot 1002, the user can bring up additional instructional content 1004 to explain the concepts presented in the presentation area of the display description or in the text box. This additional content 1004 may comprise further examples of the concepts being presented, or a more detailed explanation of an existing example. The hot spot feature recognizes that some of the training material may need to be presented in greater detail or in more than one context for the user to sufficiently grasp the subject matter.

A number of other hot spot training aids can be provided consistent with this disclosure. For example, “rollover” hot spots can be provided on various parts of an illustration that enable the user to access textual information about those parts of the illustration. Similarly, “branching” hot spots as explained above can be provided that enable the user to access more explicit graphical information on a particular aspect of an illustration. This graphical information can include, for example, close-ups of a particular part of a chart or diagram. Further, “word-choice” hot spots as explained above can be provided that display a sentence with a word-choice option and ask the user to select the word that makes the sentence correct. “Correct order” hot spots can also be provided adjacent to items in a list. When a correct order hot spot is selected, it displays a number corresponding to the order in which the item was selected. The items should be selected in the correct order for the user to demonstrate understanding of the subject matter. “Fill in the blank” hot spots are accordingly hot spots wherein the user types in text to correctly complete a sentence. And finally, “select the correct choice” hot spots can be used where, for example, a question is asked on the screen and four different graphical choices are provided. The user selects which of the four graphical choices is the best answer to the question posed.

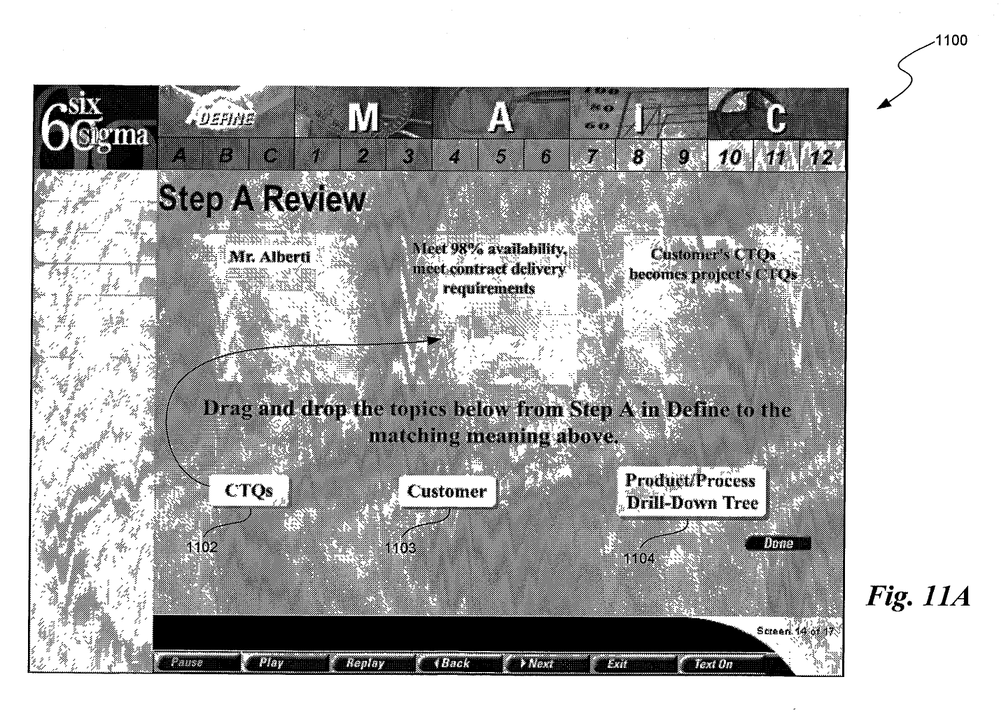

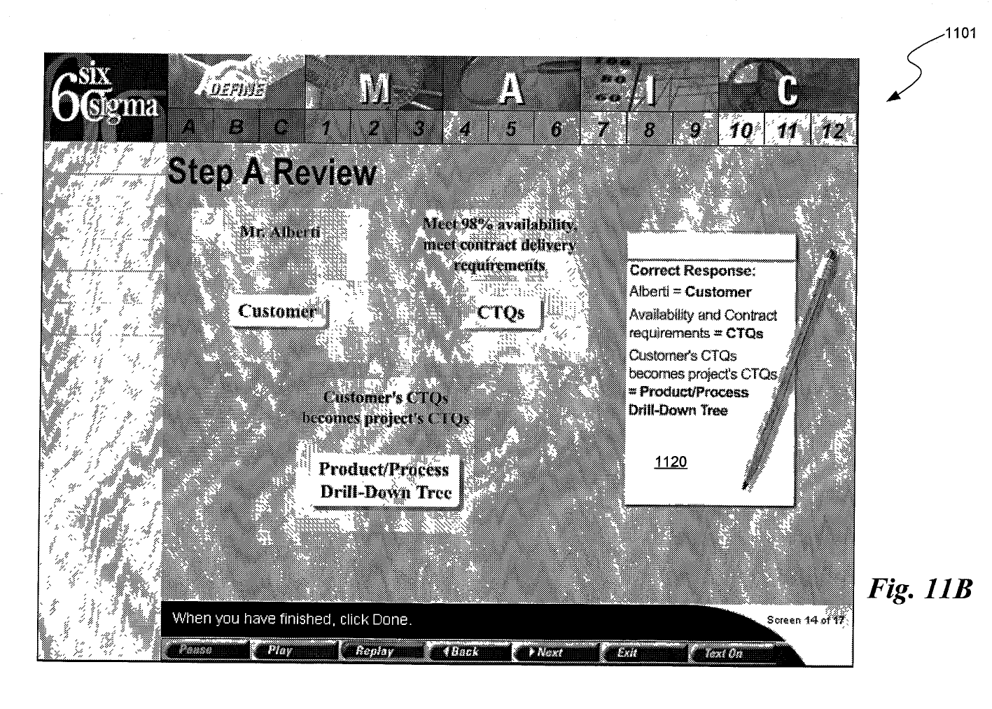

The training provided with each step of each phase module can include review display descriptions that review the subject matter presented in that step. FIG. 11A, for example, is a diagram illustrating a review display description 1100 containing drag-and-drop content in accordance with an embodiment. The user demonstrates his or her command of the subject matter by dragging topic icons 1102, 1103 and 1104 in the lower portion of the presentation area to a matching meaning 1112, 1113 or 1114 in the upper portion. FIG. 11B is a diagram illustrating a corresponding answer display description 1101 with the topic icons correctly positioned adjacent to their correct meanings. An answer box 1120 verifies that the user has correctly answered the review question.

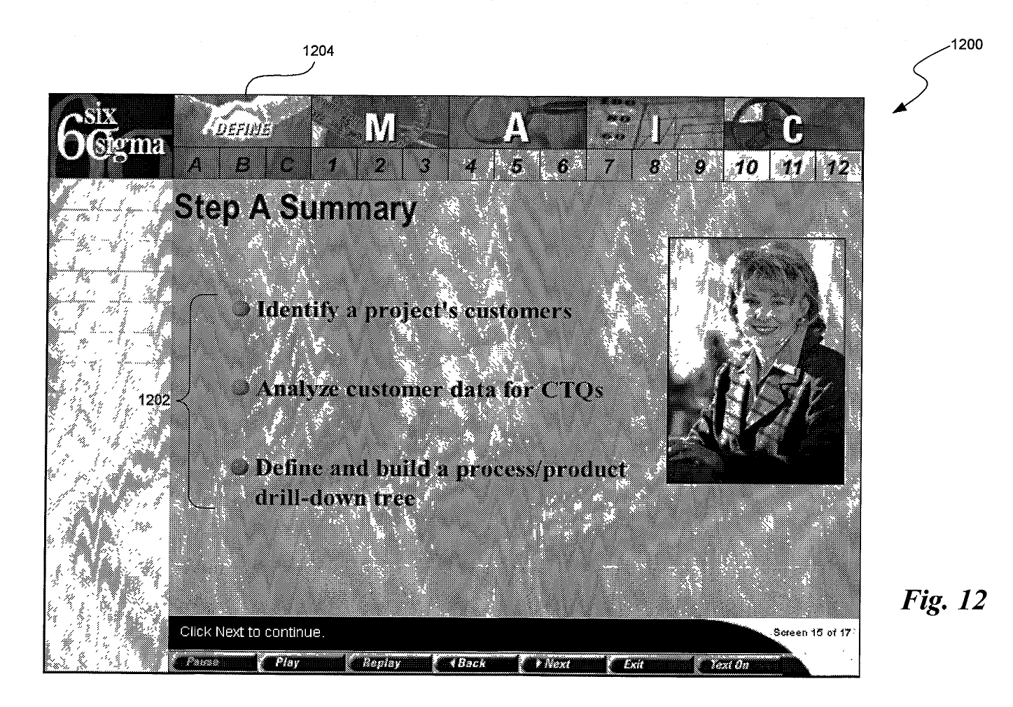

In one embodiment of the program, the training associated with each step of each phase module concludes with a summary of the fundamental concepts related to that step. FIG. 12, for example, is a diagram illustrating a summary display description 1200 in accordance with this embodiment. The display description 1200 includes objectives 1202 that summarize the main objectives of step A of the define phase module. The highlighted define icon 1204 provides a visual indication that the user is currently in the define phase.

After the user has completed the three lesson steps of a phase module, the training program presents a phase review that serves as a progress check at the conclusion of the phase module. The phase review is comprised of a short summary and a phase quiz. The short summary covers key points presented in the three lessons of that phase module. The phase quiz in one embodiment contains six questions addressing the phase module subject matter.

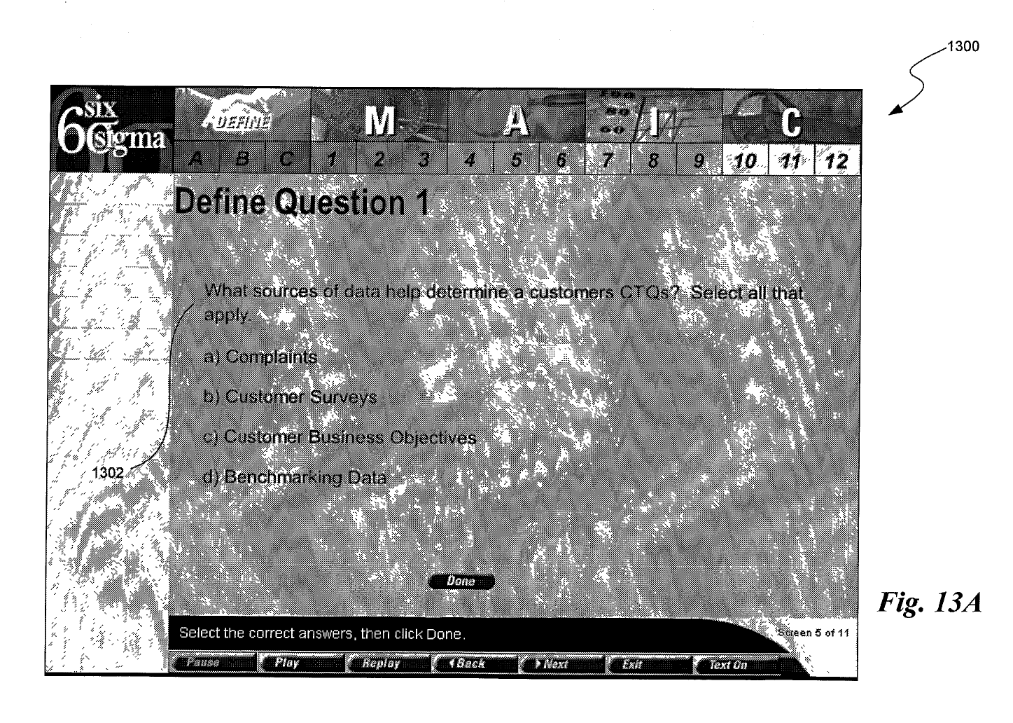

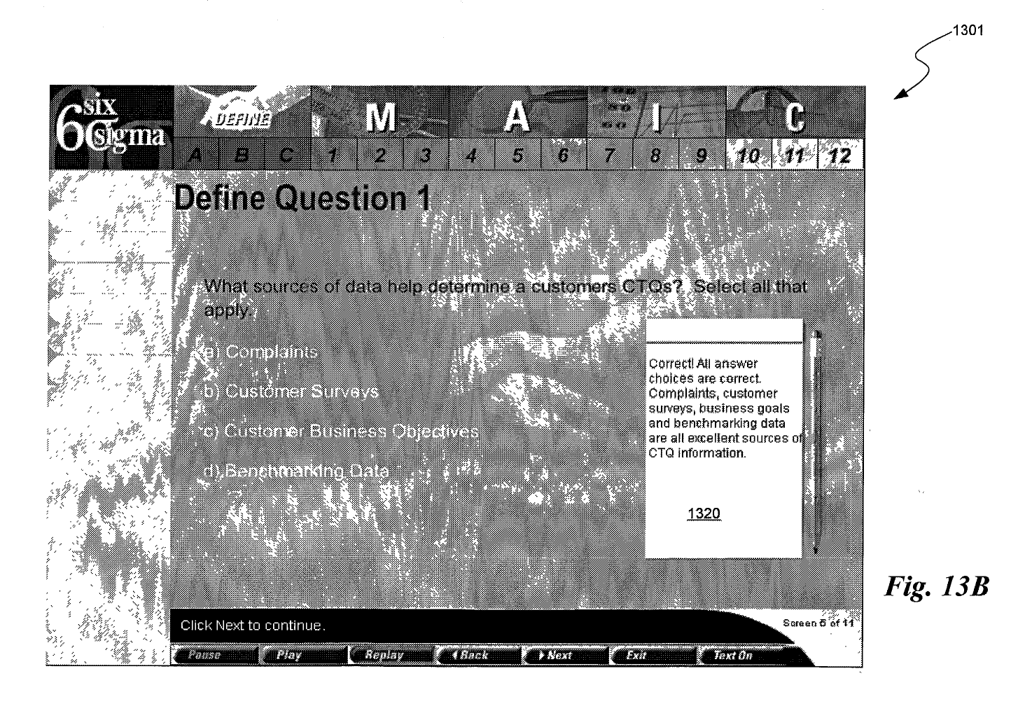

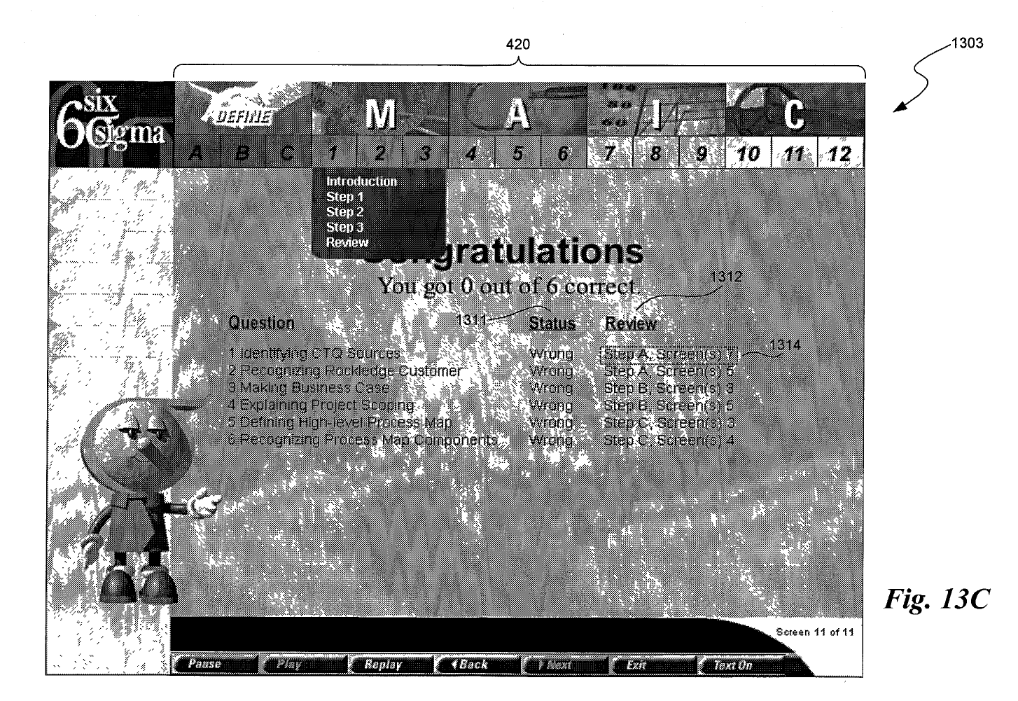

FIG. 13A is a diagram illustrating a phase quiz display description 1300 in accordance with an embodiment. A multiple choice question 1302 related to the define phase module is presented. The user selects all the correct answers that apply to the question posed. After selecting a done button 1304, an answer display description is presented. FIG. 13B is a diagram illustrating an answer display description 1301 in accordance with this embodiment. An answer box 1320 in the right-hand portion of the presentation area indicates to the user that his or her answer was correct.

In one embodiment, a feedback display description is presented at the completion of each phase quiz. FIG. 13C is a diagram illustrating a feedback display description 1303 in accordance with this embodiment. The feedback display description 1303 has a question field 1310, a status field 1311, and a review field 1312. These fields display the user's score on the phase quiz and suggest review material for each question. In another embodiment, various aspects of the display description 1303 can be “feedback” hot spots, such that by selecting one of the feedback hot spots the user will be presented with a previously-displayed display description containing training material corresponding to a selected question. For example, in one embodiment the “step A review text” icon 1314 can be a feedback hot spot such that by selecting this hot spot the user will bring up the display description or descriptions that contain training material corresponding to question 1. In other embodiments, other aspects can be feedback hot spots.

Completion of the phase quiz completes the phase module, and the user can now proceed to another phase module. As explained above with reference to FIG. 5, the top menu 420 provides the user with a visual indication of which phase modules have yet to be completed.

Although the display descriptions of FIGS. 2 through 13C have been described above in regard to the define step of the Six Sigma process, those of skill in the art will understand that similar display descriptions containing appropriate subject matter can be used to present the remaining core phases of the Six Sigma process—namely the measure, analyze, improve, and control phases as shown in FIG. 1.

At the conclusion of the phase modules 114 through 118 as shown in FIG. 1, a cumulative quiz score is calculated for all the phase quizzes. In one embodiment, the training program presents a program review quiz to those users who fail to attain a cumulative score of 70 percent or greater. Other cumulative scores can be established as a cut-off score to suit different criteria in other embodiments. The program review quiz in one embodiment includes all of the questions from the five individual phase quizzes. For example, if each phase quiz contains six questions, then the program review quiz contains all 30 of the phase quiz questions. In other embodiments, other questions can be selected for the program review quiz.

In one aspect of this embodiment, the training program presents a knowledge check to those users who received a cumulative quiz score of 70 percent or greater. The knowledge check serves as a final exam for the entire Six Sigma training program. In one embodiment, this exam contains 30 questions, with at least one question addressing each of the learning objectives covered in the lesson sections of the training program. In other embodiments, this exam can contain between 25 and 75 such questions. In yet other embodiments, other numbers and other types of questions can be used. The questions can be presented in many different forms. For example, questions can be presented in multiple choice form including a question text, a correct answer, and three distracter answers. The identification of which Six Sigma objective is addressed by the question, and appropriate feedback, can also be included with the question.

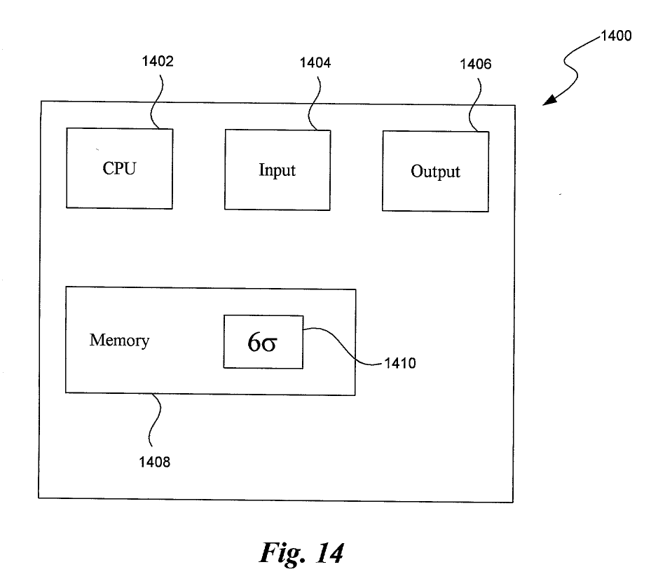

FIG. 14 is a block diagram of a computer system 1400 for implementing the computer-based quality enhancement training program in accordance with the methods described above. The computer system 1400 includes a central processing unit 1402, a memory 1408, an input device 1404, and an output device 1406. The central processing unit 1402 can include circuitry for performing computer functions, such as executing software to perform desired calculations and tasks. The input device 1404 can include automatic input devices such as a computer-readable media drive, or manual input devices such as a keypad or mouse, for inputting data into the central processing unit 1402. The output device 1406 can include devices coupled to the central processing unit 1402, such as a printer or a display screen for presenting display descriptions or other data. The computer memory 1408 can include storage media containing computer-executable instructions for performing various tasks and presenting various displays on the output device 1406. For example, the memory 1408 can include a Six Sigma component 1410 that contains computer-executable instructions for implementing the Six Sigma training program as described above in accordance with the routine 100 and the display descriptions of FIGS. 2-13C.

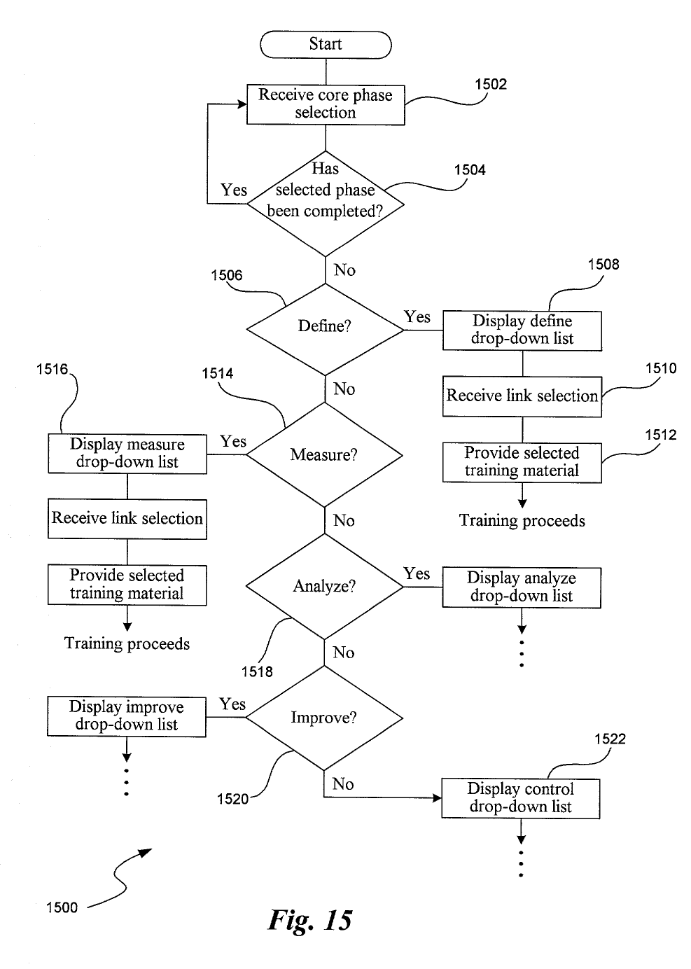

FIG. 15 is a flow diagram of a routine 1500 for displaying a selected core phase drop-down list in accordance with an embodiment. In one embodiment, the routine 1500 is used in conjunction with a main menu display description to facilitate the user's selection of core phase training material during the training program. In block 1502, the routine receives a core phase selection from the user. This selection could be the define phase, the measure phase, the analyze phase, the improve phase, or the control phase. In decision block 1504, the routine determines if the selected core phase has been previously completed by the user. If the selected core phase has been previously completed, then the routine returns to block 1502 and awaits another core phase selection. If the selected core phase has not been previously completed, then in decision block 1506 the routine determines if the define phase has been selected by the user. If in fact the define phase was selected, then in block 1508 the routine displays a define phase drop-down list. In block 1510, the user selects one of the section links from the define phase drop-down list. In block 1512, the routine responds to the selection by providing the corresponding training material, and the training program proceeds accordingly.

If the define phase was not selected by the user, then in decision block 1514 the routine determines if the measure phase was selected. If the measure phase was in fact selected, then in block 1516 the routine displays the corresponding measure phase drop-down list, and the routine proceeds as explained above for the define phase. If the measure phase was not selected by the user, then in decision block 1518 the routine determines if the analyze phase was selected. The routine proceeds from this point as explained above with respect to the define and measure phases. If in decision block 1520 the improve phase was not selected by the user, then the routine proceeds to display the control phase drop-down list in block 1522. There is no need to determine if in fact the control phase was selected by the user, because at this point in the routine the control phase is the only remaining alternative.

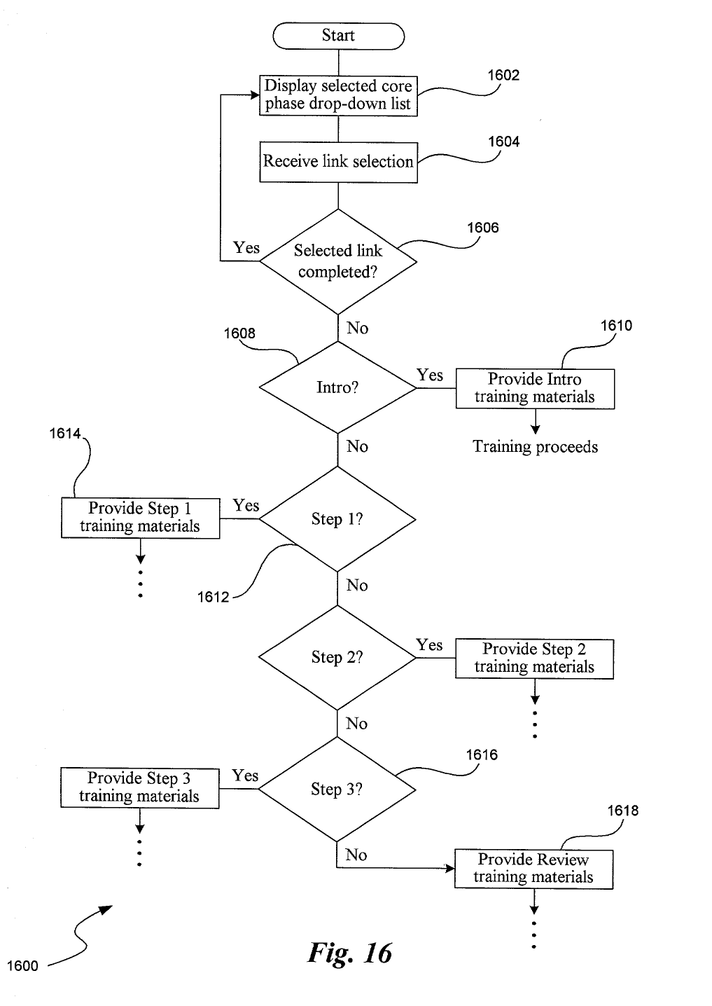

FIG. 16 is a flow diagram of a routine 1600 for providing selected training material in accordance with an embodiment. In one embodiment, the routine 1600 is used to provide training material corresponding to a selected section of a core phase. In block 1602, the routine 1600 displays a core phase drop-down list selected by the user. The core phase drop-down list contains a plurality of links to different sections of the core phase. In one embodiment, the section links correspond to an introduction section, a step 1 section, a step 2 section, a step 3 section, and a phase review section as shown on a main user display description. In block 1604, the routine receives a link selection from the user.

In decision block 1606, the routine determines if the selected link has already been completed during the training program. If the selected link has been completed, then the routine returns to block 1602 and awaits another link selection. If the selected link has not been completed, then in decision block 1608, the routine determines if the introduction link was selected. If the introduction link was in fact selected, then in block 1610 the routine provides the introduction training materials and the training program proceeds accordingly. If the introduction link was not selected, then in decision block 1612 the routine determines if the step 1 link was selected. If the step 1 link was in fact selected, then in block 1614 the routine provides the step 1 training materials and the training program proceeds accordingly. If the step 1 link was not selected, then the routine determines if the step 2 or step 3 links were selected in the same manner as explained above with respect to the introduction and step 1 links. If in decision block 1616 the routine determines that the step 3 link was not selected, then the routine provides the phase review training material in block 1618. There is no need for the routine to determine if the phase review link was in fact selected, because at this point in the routine the phase review section is the only remaining selection available to the user.

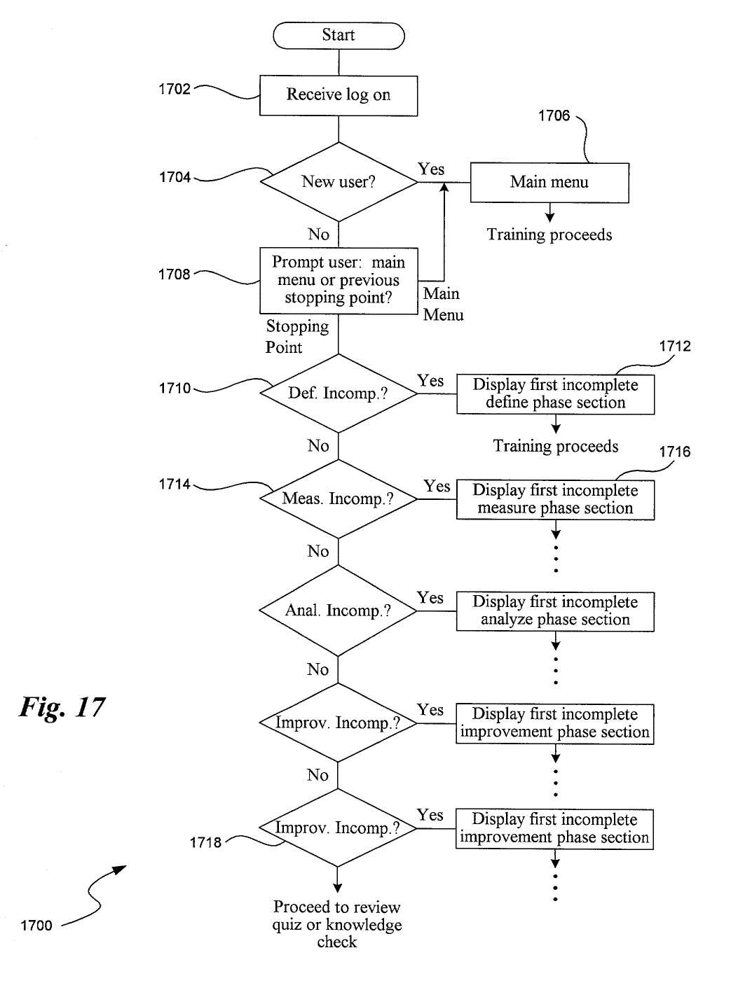

FIG. 17 is a flow diagram of a routine 1700 for returning a user to a previous stopping point in a computer-based training program in accordance with an embodiment. In block 1702, the routine receives the user's log on information. In decision block 1704, the routine determines if the user is a new user. If the user is a new user, then in block 1706 the routine displays a main menu display description. The user can select from the phase icons on the main menu display description to embark on the training program as discussed above. If the user is not a new user (i.e., the user is a return user), then in block 1708 the routine prompts the user to determine if the user would like to return to the main menu display description or instead return to the previous stopping point in the training program.

If the user elects to return to the previous stopping point, then in decision block 1710 the routine determines if the define phase of the training program was partially completed by the user. This determination is based on the user's prior work in the training program which has been stored on a suitable memory device by the program. If the routine determines that the define phase of the training program is in fact incomplete, then in block 1712 the routine displays the first incomplete section of the define phase, and the training program proceeds accordingly. If the routine determines that the define phase was completed by the user, then in decision block 1714 the routine determines if the measure phase was partially completed by the user. If in fact the measure phase is only partially complete, then in block 1716 the routine displays the first incomplete section of the measure phase, and the training program proceeds accordingly. The steps explained above repeat for the analyze and improve phases until the routine either finds a partially completed phase or arrives at the control phase in decision block 1718. If the control phase is found to have been completed by the user, then the routine proceeds to the exam portion of the training program. The exam portion can include either the knowledge check or the review quiz depending on the user's cumulative quiz score as explained above.

In general, and unless specifically set forth to the contrary, the claims should not be construed as limited to the specific embodiments disclosed in the specification and claims, but should instead be construed to include all methods and systems for computer-based training under the teachings disclosed herein. For example, a computer-based training program can be constructed in accordance with the present disclosure to teach essentially any subject matter that can be broken down into discrete phases or modules. Accordingly, the present disclosure is not limited except by the appended claims.

We claim:

1. A computer-readable medium whose contents cause a computer system to provide training material related to a quality enhancement process, the training material comprising display descriptions provided by a method comprising:
receiving a request for the training material;
providing a case study display description;
providing an introduction display description, the introduction display description comprising an introduction to the quality enhancement process;
providing a main menu display description, the main menu display description comprising links to training material related to core phases of the quality enhancement process;
receiving a request for training material related to a selected core phase of the quality enhancement process; and
providing the requested training material related to the selected core phase.

2. The computer-readable medium of claim 1 wherein the selected core phase is a first selected core phase, and further comprising:
receiving a request for training material related to a second selected core phase of the quality enhancement process; and
providing the requested training material related to the second selected core phase.

3. The computer-readable medium of claim 1 wherein each core phase of the quality enhancement process contains three basic steps, and wherein the links to training material included on the main menu display description comprise:
a phase introduction link;
a first step link;
a second step link;
a third step link; and
a phase review link.

4. The computer-readable medium of claim 3 wherein the quality enhancement process is a Six Sigma quality enhancement process and the core phases include the define phase, the measure phase, the analyze phase, the improve phase, and the control phase, and wherein:
selecting a phase introduction link causes a display description containing the three basic steps of the selected phase to be presented; and
selecting a phase review link causes a display description containing a phase quiz to be presented.

5. The computer-readable medium of claim 1 wherein the quality enhancement process is a Six Sigma quality enhancement process and the core phases include the define phase, the measure phase, the analyze phase, the improve phase, and the control phase.

6. The computer-readable medium of claim 1 wherein the provided training material related to the selected core phase comprises a phase quiz.

7. The computer-readable medium of claim 6 wherein the selected core phase is a first selected core phase and the phase quiz is a first phase quiz, and further comprising:
receiving a request for training material related to a second selected core phase of the quality enhancement process;
providing the requested training material related to the second selected core phase, the provided training material related to the second selected core phase comprising a second phase quiz; and
providing a cumulative quiz score, the cumulative quiz score being based on a first quiz score associated with the first phase quiz and a second quiz score associated with the second phase quiz.

8. The computer-readable medium of claim 7 further comprising:
comparing the cumulative quiz score to a predetermined percentage of correct answers; and
based on the comparison, providing additional examination material.

9. The computer-readable medium of claim 8, wherein:
if the cumulative quiz score is less than the predetermined percentage, then the additional examination material is a review quiz; and
if the cumulative quiz score is greater than or equal to the predetermined percentage, then the additional examination material is a final exam.

10. The computer-readable medium of claim 9 wherein the review quiz is comprised of questions from the phase quizzes.

11. The computer-readable medium of claim 8 wherein the predetermined percentage is at least approximately 70 percent.

12. The computer-readable medium of claim 1 wherein providing the requested training material related to the selected core phase comprises optionally providing at least a portion of the requested training material in either audio or written script format.

13. A method in a computer system for providing training material related to a quality enhancement process, the method comprising:
receiving a request for the training material;
providing a case study display description;
providing an introduction display description, the introduction display description comprising an introduction to the quality enhancement process;
providing a main menu display description, the main menu display description comprising links to training material related to core phases of the quality enhancement process;
receiving a request for training material related to a selected core phase of the quality enhancement process; and
providing the requested training material related to the selected core phase.

14. The method of claim 13 wherein the links to training material included on the main menu display description comprise:
a phase introduction link;
a first step link;
a second step link;
a third step link; and
a phase review link.

15. The method of claim 14 wherein the quality enhancement process is a Six Sigma quality enhancement process and the core phases include the define phase, the measure phase, the analyze phase, the improve phase, and the control phase, wherein each core phase includes three basic steps, and wherein:
selecting a phase introduction link causes a display description containing the three basic steps of the selected phase to be presented; and
selecting a phase review link causes a display description containing a phase quiz to be presented.

16. The method of claim 13 wherein the quality enhancement process is a Six Sigma quality enhancement process and the core phases include the define phase, the measure phase, the analyze phase, the improve phase, and the control phase.

17. The method of claim 13 wherein the provided training material related to the selected core phase comprises a phase quiz.

18. The method of claim 17 wherein the selected core phase is a first selected core phase and the phase quiz is a first phase quiz, and further comprising:
receiving a request for training material related to a second selected core phase of the quality enhancement process;
providing the requested training material related to the second selected core phase, the provided training material related to the second selected core phase comprising a second phase quiz; and
providing a cumulative quiz score, the cumulative quiz score being based on a first quiz score associated with the first phase quiz and a second quiz score associated with the second phase quiz.

19. The method of claim 18 further comprising:
comparing the cumulative quiz score to a predetermined percentage of correct answers; and
based on the comparison, providing additional examination material.

20. The method of claim 19, wherein:
if the cumulative quiz score is less than the predetermined percentage, then the additional examination material is a review quiz; and
if the cumulative quiz score is greater than or equal to the predetermined percentage, then the additional examination material is a final exam.

21. The method of claim 20 wherein the review quiz is comprised of questions from the phase quizzes.

22. The method of claim 19 wherein the predetermined percentage is at least approximately 70 percent.

23. The method of claim 13 wherein providing the requested training material related to the selected core phase comprises providing audio training material.

24. The method of claim 13 wherein providing the requested training material related to the selected core phase comprises providing textual training material.

25. The method of claim 13 wherein providing the requested training material related to the selected core phase comprises optionally providing audio or textual training material.

26. A method for providing training material related to a quality enhancement process, the quality enhancement process being comprised of a plurality of core phases, the method comprising:
providing a case study as a context for the training material;
providing an introduction to the fundamental concepts associated with the quality enhancement process;
providing a first set of training materials related to a first core phase of the quality enhancement process; and
providing a second set of training materials related to a second core phase of the quality enhancement process.

27. The method of claim 26 wherein the quality enhancement process is a Six Sigma quality enhancement process, and wherein the first core phase is a define phase and the second core phase is a measure phase.

28. The method of claim 26 wherein the first set of training materials includes a first phase quiz and the second set of training materials includes a second phase quiz, and wherein the method further comprises:
providing a cumulative quiz score, the cumulative quiz score being based on a first quiz score associated with the first phase quiz and a second quiz score associated with the second phase quiz.

29. The method of claim 28 further comprising:
comparing the cumulative quiz score to a predetermined percentage of correct answers; and
based on the comparison, providing additional examination material related to the first and second core phases.

30. The method of claim 29 wherein the additional examination material is comprised of questions from the phase quizzes.

31. The method of claim 29 wherein the predetermined percentage is at least approximately 70 percent.

32. A computer-readable medium comprising a main menu display description for a quality enhancement training program, the main menu display description comprising:
a top menu positioned toward the top portion of the main menu display description, the top menu including a plurality of phase module icons; and
a left side menu positioned toward the left portion of the main menu display description, the left side menu including an overview icon, a tools icon, and a glossary icon.

33. The computer-readable medium of claim 32 wherein the quality enhancement training program is directed to a Six Sigma quality enhancement process, wherein the Six Sigma quality enhancement process includes five core phases comprising a define phase, a measure phase, an analyze phase, an improve phase, and a control phase, and wherein each phase module icon corresponds to one of the five core phases.

34. The computer-readable medium of claim 33 wherein each phase module icon includes a drop-down list, the drop-down list containing links to training material directed to the corresponding phase of the Six Sigma process.

35. The computer-readable medium of claim 33 wherein each core phase of the Six Sigma quality enhancement process comprises three basic steps, and wherein each phase module icon includes a drop-down list, the drop-down list containing links to a phase introduction display description, a first step display description, a second step display description, a third step display description, and a phase review display description.

36. The computer-readable medium of claim 32 wherein the main menu display description further comprises:
a locator bar positioned adjacent to the top menu, the locator bar comprising a plurality of numbered portions, the numbered portions providing a visual indication of which phase modules have been completed.

37. The computer-readable medium of claim 36 wherein the numbered portions provide a visual indication of which phase modules have been completed by differential shading.

38. The computer-readable medium of claim 36 wherein the quality enhancement training program is directed to a Six Sigma quality enhancement process, wherein the Six Sigma quality enhancement process includes five core phases comprising a define phase, a measure phase, an analyze phase, an improve phase, and a control phase, wherein each phase module icon corresponds to one of the five core phases, wherein each core phase of the Six Sigma quality enhancement process comprises three basic steps, and wherein each numbered portion corresponds to one step, the numbered portions corresponding to completed steps having a darker shade than the numbered portions corresponding to incomplete steps.

39. A computer-readable medium comprising a display description containing instructional material for a Six Sigma quality enhancement process, wherein the Six Sigma quality enhancement process includes five core phases comprising a define phase, a measure phase, an analyze phase, an improve phase, and a control phase, the display description comprising:
a top menu positioned toward the top portion of the main menu display description, the top menu including a plurality of phase module icons, wherein each phase module icon corresponds to one of the five core phases of the Six Sigma process;
a left side menu positioned toward the left portion of the main menu display description, the left side menu including an overview icon, a tools icon, and a glossary icon;
a display field positioned toward the central portion of the main menu display description, the display field presenting instructional content directed to one of the core phases of the Six Sigma process;
a text box, the text box containing explanatory text related to the instructional content presented in the display field; and
a navigation bar, the navigation bar providing controls for altering the content presented in the display field.

40. The computer-readable medium of claim 39 wherein the display description further comprises a training aid icon, wherein selection of the training aid icon causes additional explanatory text to be displayed, the additional explanatory text being related to the instructional content presented in the display field.

41. The computer-readable medium of claim 39 wherein the display description further comprises a multiple choice question related to the Six Sigma quality enhancement process.

42. The computer-readable medium of claim 39 wherein the display description further comprises an audio-video sequence related to the Six Sigma quality enhancement process.

43. The computer-readable medium of claim 39 further comprising a cartoon character, the cartoon character comprising the letter sigma of the Greek alphabet.

44. The computer-readable medium of claim 39 further comprising an audio training portion containing audio instructional material that complements the instructional material of the display description.

45. The computer-readable medium of claim 44 wherein the navigation bar further includes an audio control for controlling the audio training portion, wherein selecting the audio control discontinues the audio training portion and causes at least a portion of instructional text to be displayed in the text box.

46. The computer-readable medium of claim 45 wherein deselecting the audio control continues the audio training portion and discontinues the at least a portion of text displayed in the text box.

47. A computer system for providing training material related to a quality enhancement process, the training material comprising display descriptions, the computer system comprising:
means for receiving a request for the training material;
means for providing a case study display description;
means for providing an introduction display description, the introduction display description comprising an introduction to fundamental concepts of the quality enhancement process;
means for providing a main menu display description, the main menu display description comprising links to training material related to core phases of the quality enhancement process;
means for receiving a request for training material related to a selected core phase of the quality enhancement process; and
means for providing the requested training material related to the selected core phase.

48. The computer system of claim 47 wherein the selected core phase is a first selected core phase, and further comprising:
means for receiving a request for training material related to a second selected core phase of the quality enhancement process; and
means for providing the requested training material related to the second selected core phase.

49. The computer system of claim 47 wherein each core phase of the quality enhancement process contains three basic steps, and wherein the links to training material included in the main menu display description comprise:
a phase introduction link;
a first step link;
a second step link;
a third step link; and
a phase review link.

50. The computer system of claim 47 wherein the quality enhancement process is a Six Sigma quality enhancement process, and the core phases include the define phase, the measure phase, the analyze phase, the improve phase, and the control phase.

51. The computer system of claim 47 wherein the selected core phase is a first selected core phase and the provided training material related to the first selected core phase includes a first phase quiz, and further comprising;
means for receiving a request for training material related to a second selected core phase of the quality enhancement process;
means for providing the training material related to the second selected core phase, the provided training material related to the second selected core phase comprising a second phase quiz; and
means for providing a cumulative quiz score, the cumulative quiz score being based on a first quiz score associated with the first phase quiz and a second quiz score associated with the second phase quiz.

52. The computer system of claim 51 further comprising:
means for comparing the cumulative quiz score to a predetermined percentage; and
means for providing additional examination material.

53. A computer system for providing training material related to a Six Sigma quality enhancement process, the training material comprising display descriptions, the computer system comprising:
a Six Sigma component containing computer-executable instructions for providing the Six Sigma training material by a method comprising:
receiving a request for the training material;
providing a case study display description;
providing an introduction display description, the introduction display description comprising an introduction to the fundamental concepts associated with the Six Sigma process;
providing a main menu display description, the main menu display description comprising links to training material related to core phases of the Six Sigma process;
receiving a request for training material related to a selected core phase of the Six Sigma process; and
providing the requested training material related to the selected core phase;
a central processing unit for executing the computer-executable instructions for providing the Six Sigma training material; and
an output device for displaying the Six Sigma training material.

54. A method in a computer system for presenting information, comprising:
providing an audio version and a textual version of the information to be presented;
receiving a selection to output the provided audio version or the provided textual version;
when the received selection is to output the provided audio version, outputting the provided audio version without outputting the provided textual version; and
when the received selection is to output the provided textual version, outputting the provided textual version without outputting the provided audio version.

55. The method of claim 54 wherein the information is information related to a quality enhancement training program, and wherein the method further comprises:
providing a display description, the display description including a control for selecting to output the provided audio version or the provided textual version, wherein receiving a selection to output the provided audio version or the provided textual version comprises receiving a selection implemented with the control.

56. The method of claim 54 further comprising:
providing a display description, wherein outputting the provided textual version without outputting the provided audio version comprises scrolling text from right to left across a portion of the display description.

57. The method of claim 54 wherein the information is information related to a quality enhancement training program, and wherein the method further comprises:
providing a display description, the display description comprising a text box, wherein outputting the provided textual version without outputting the provided audio version comprises displaying text in the text box.

58. The method of claim 57 wherein:
the quality enhancement program is a Six Sigma program;
the provided audio version of the information is a narrative of the Six Sigma program; and
the provided textual version of the information is a written script of the provided audio version.
